(19) United States
(12) Patent Application Publication
(10) Pub. No.: US 2012/0017171 A1
(43) Pub. Date: Jan. 19, 2012

(54) INTERFACE DISPLAY ADJUSTMENT METHOD AND TOUCH DISPLAY APPARATUS USING THE SAME

(76) Inventors: Wen-Chieh TSENG, Taipei (TW); Wei-Wen Luo, Taipei (TW); Yi-Lung Tsai, Taipei (TW); Yu-Wei Hsiang, Taipei (TW); Yi-Chen Chen, Taipei (TW)

(21) Appl. No.: 13/182,125

(22) Filed: Jul. 13, 2011

Related U.S. Application Data
(60) Provisional application No. 61/364,025, filed on Jul. 14, 2010.

(51) Int. Cl. G06F 3/048

(52) U.S. Cl. 715/794

(57) ABSTRACT

An interface display adjustment method applied to a touch display module is disclosed. The interface display adjustment method includes the following steps: displaying a first interface and a second interface at the touch display module, in which the second interface includes a plurality of selecting units; receiving a touch event at the touch display module and adjusting the first interface to partially display the selecting units of the second interface. A touch display apparatus using the interface display adjustment method is disclosed as well.

### CROSS REFERENCE TO RELATED APPLICATIONS

This Non-provisional application claims the benefit of the filing date of provisional application No. 61/364,025 filed Jul. 14, 2010, under 35 USC & 119 (e).

### BACKGROUND OF THE INVENTION

1. Field of Invention

The invention relates to a display adjustment method and a touch display apparatus using the same and, more particularly, to a user interface or operating interface display adjustment method and a touch display apparatus using the same.

2. Related Art

To improve production and efficiency to meet requirements of industry with fierce completion and high developing speed, electrical products develop simultaneous multitask technology, especially, consumer portable products. Due to limitation of size and endurance of a conventional portable touch display apparatus, only one program is enabled or one function is executed at a time, which is usually called simplex. Thus, other programs cannot be executed at background of the portable touch display apparatus, which does not meet expectations of consumers.

Currently, with the great development of software and hardware, it is not difficult to achieve simultaneous multitask for manufacturers of smart mobile phone or tablet PC, and they engage in developing basic functions. However, the user has a new trouble when he or she operates in client.

FIG. 1A is a schematic diagram showing images of a conventional touch display apparatus in executing interface display method. A touch display apparatus E1 includes a touch display module 1 for displaying an image frame 12. In usage, in order to use full size of the screen, the display image of a control interface 11 is adjusted to display in full screen when executing multitask simultaneously. For example, when the functions of reading and listening to music are executed simultaneously, the image in the reading page is displayed in full screen. If the user wants to change the current music track, he or she should press a control button 13 to make the frame 12 go back to a main control interface 14 (as shown in FIG. 1B). Then, the user touches a music icon 141 to make the frame 12 jump to or pop up a music play interface 15, as shown in FIG. 1C, so as to change the music track.

In the switch process above, users have to input information repeatedly and also have to spend time to find the target interface icon at the control interface 14 or at a theme menu, which is rather complicated in practical usage and inconvenience in intuitive operation. Moreover, when multitask programs are under executing mistakes may be happened while selection, furthermore, the user has to switch between the main control interface 14 and selection pages of the theme menu many times. Consequently, some products provide tabs for users to utilize. However, the tab is relatively small in size and is therefore difficult to be selected. Additionally, after the user selects and executes the tab, the display position and size of the pop-up interface is different from that of the tab. Thus, the user needs to find out the menu button and get used to the variation of the interface for a while.

### SUMMARY OF THE INVENTION

An interface display adjustment method and a display apparatus using the same are provided to display at least two different interfaces at the screen in multitask executing. The user can rapidly and intuitively switch between interfaces with simple operation in visually perceptible situation, so as to meet requirement of diversified operation.

An interface display adjustment method and a display apparatus using the same as disclosed herein are used to simulate a feeling of moving and switching between physical objects. When the user operates the touch display apparatus to execute programs in multitask, he or she can easily and uninterruptedly find out the needed function options between different interfaces without learning and achieves a better operating experience.

The interface display adjustment method is applied to a touch display module. The interface display adjustment method includes the following steps: displaying a first interface and a second interface in which the second interface includes a plurality of selecting units at the touch display module; receiving a touch event at the touch display module; and adjusting the first interface to partially display the selecting units of the second interface.

A touch display apparatus is further provided. It includes a touch display module. The touch display module displays a first interface and a second interface, and the second interface includes a plurality of selecting units. When the touch display module receives a touch event, the first interface is adjusted to partially display the selecting units of the second interface.

As stated above, the interface display adjustment method and the touch display apparatus disclosed herein the embodiment displays two interfaces simultaneously in multitask operation via the touch display module, and the selecting units of the second interface are covered when they're not under using, the first interface will occupy a larger display space, which is more convenient for the users to operate and read. However, when the user wants to execute other programs, he or she can control the selecting units of the second interface to partially display by adjusting the first interface. After the touch action, the first interface is adjusted to display the selecting units of the second interface that were partially covered by the first interface, and the selecting units are recognizably displayed partially or completely. Accordingly, since the second interface is not shown in a turning or popping up mode, the users will get used for the new frames more easily, and no need to look for the position of the selecting units again. The operation process is smooth and get closer in man-machine coordination.

Compared to the conventional technology, the second interface and the selecting units in the embodiment can be partially displayed at the touch display module even not in operation, and the users can still get the outline of the interface easily. Thus, after the interface has been switched, the users don't have to bring out previous memory to check where the icon were placed, and leads to execute functions at the second interface intuitively. It does not waste processing time and efficiency of the electronic devices while turning or displaying interfaces. On the contrary, as the conventional method, when the frequency of changing interfaces is high, the lag of browsing and discomfort in unintuitive operation would impact the willing of usage.

Furthermore, the interface display adjustment method and the touch display apparatus disclosed herein provided more human functions which can be operated in a way conforming to everyday habits of the users such as to simulate habit of operating simultaneous multitask. For example, when the user reads and takes notes simultaneously, he or she commonly puts the book on the note. Although the note is covered partially, the user still knows the general position of the note and the grids on the note. Once the user writes, he or she only needs to move the book to expose the covered note, and then he or she can write on appropriate grids spontaneously. The interface display adjustment method disclosed herein conforms the habit of the multitask operation as stated above, and thus the user-friendly experience and the willing of usage are improved.

These and other features, aspects and advantages of the present invention will become better understood with regard to the following description, appended claims, and accompanying drawings.

### BRIEF DESCRIPTION OF THE DRAWINGS

FIG. 1A to FIG. 1C are schematic diagram showing different interfaces are switched on a conventional display apparatus;

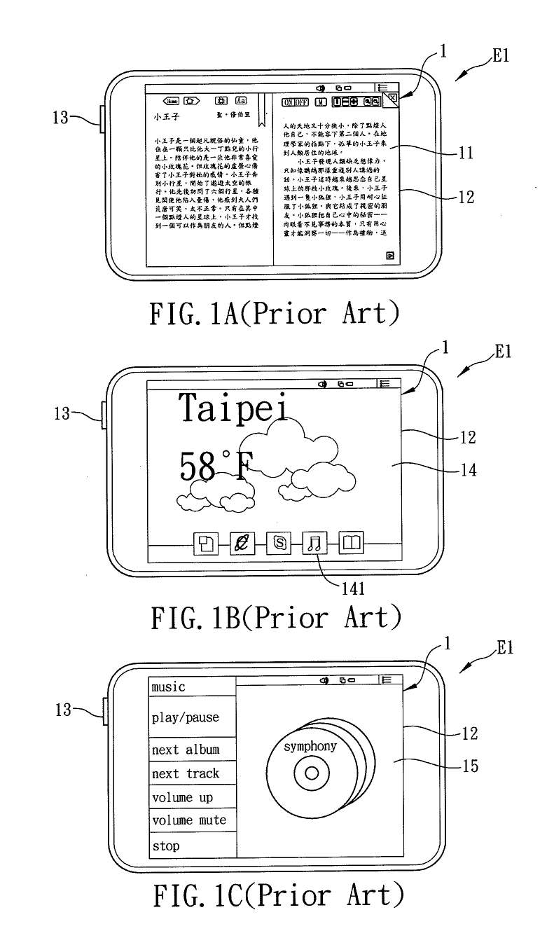

FIG. 2A is a schematic diagram showing a display apparatus in a first embodiment;

FIG. 2B is a schematic diagram showing an display image of a display apparatus in FIG. 2A;

FIG. 2C is a schematic diagram that partially showing the display image in FIG. 2B is perspective;

FIG. 3A and FIG. 3B are schematic diagrams showing the actions when the touch display module in the first embodiment receives different touch events;

FIG. 4A to FIG. 4D are schematic diagrams showing images of the touch display module in different modes after a first interface is adjusted according to a first embodiment;

FIG. 5A, FIG. 5B and FIG. 5C are schematic diagrams showing the images of the touch display module before the first interface is adjusted as well as the first interface is adjusted in a second embodiment;

FIG. 6 is a schematic diagram showing display images of the touch display module of the touch display apparatus in a third embodiment; and

FIG. 7 is a flow chart showing steps of an interface display adjustment method in an embodiment.

### DETAILED DESCRIPTION OF THE INVENTION

An interface display adjustment method and a touch display module in the embodiments are illustrated with relating figures, and the same symbols denote the same components.

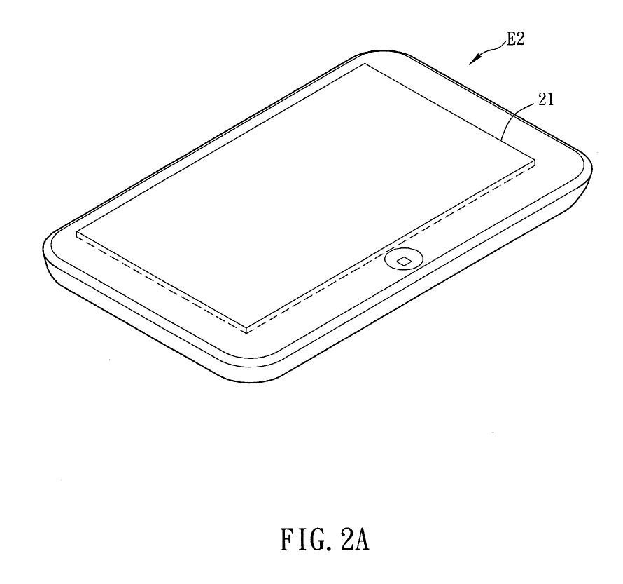

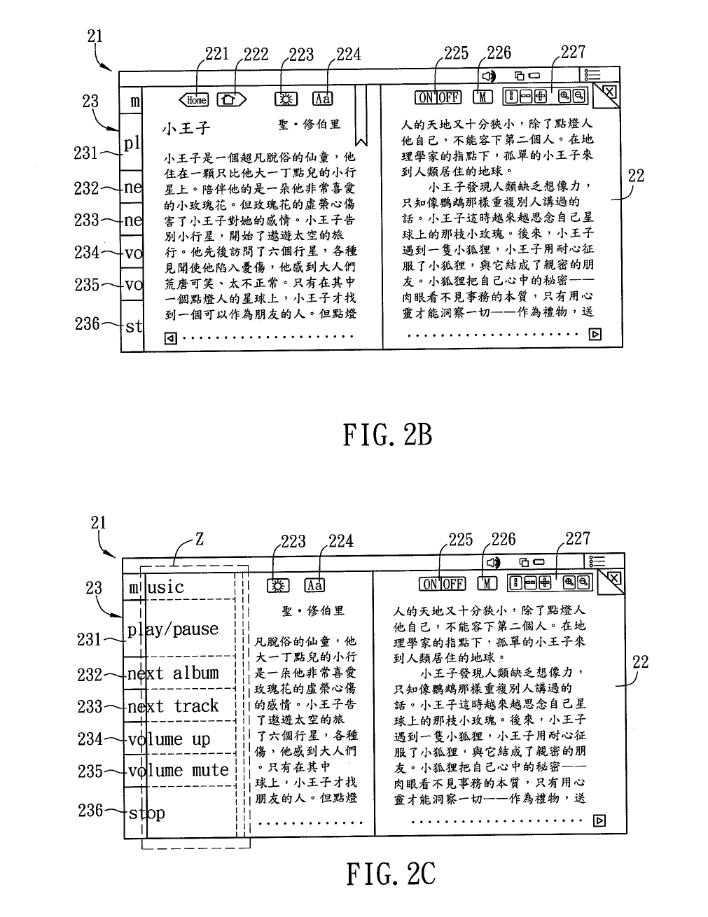

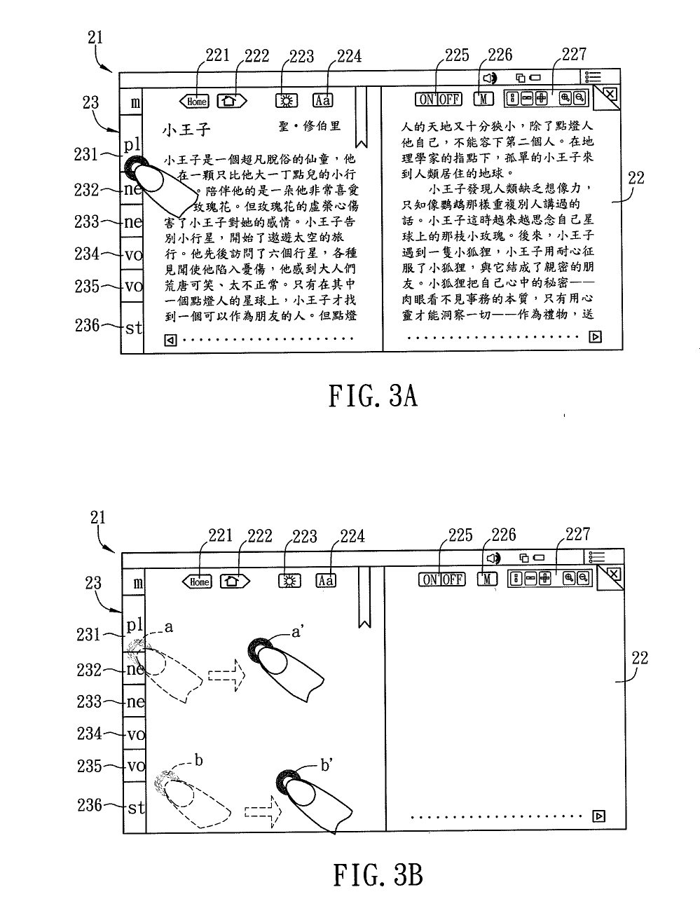

FIG. 2A is a schematic diagram showing a display apparatus in a first embodiment, such as a touch display apparatus, and FIG. 2B is a schematic diagram showing a display image of a touch display module of the touch display apparatus in FIG. 2A. In the embodiment, a touch display apparatus E2 includes a touch display module 21. The touch display apparatus E2 may be a smart phone, a personal digital assistant (PDA) and a tablet PC, which is not limited herein. The touch display module 21 may be a touch panel or a touch screen, which is not limited herein. Images displayed by the touch display module are taken as an example.

The touch display apparatus E2 in the embodiment is based on multitask operation. The touch display module 21 displays images such as a first interface and a second interface as shown in FIG. 2B. However, since more than two tasks can be executed simultaneously at the multitask operation, the number of displayed interfaces is not limited in practical use. In other embodiments, the touch display module 21 may display not only the first interface 22, the second interface 23 as shown in FIG. 2B, but also a third interface, or more, which is not limited herein.

In the embodiment, the first interface 22 and the second interface 23 may be the same or different input or control interface for the users to operate the touch display apparatus. The first interface 22 and the second interface 23 are different in the embodiment. As shown in FIG. 2B, the first interface 22 is a reading control interface, and the second interface 23 is a music player interface. Moreover, an interface adjustment module 24 (as shown in FIG. 2A) is executed the same application program or different application programs to display the first interface 22 and the second interface 23 in different mode. In the embodiment, two different control interfaces, the first interface 22 and the second interface 23, are displayed by executing the same application program or operation system.

In an embodiment, the first interface 22 and the second interface 23 may be an interface of clipboard, dictionary, notepad, browser, calculator, photo gallery, e-mails, text editor or financial management, which is not limited herein.

The first interface 22 and the second interface 23 include a plurality of selecting units, respectively, to execute corresponding functions. The selecting units 231 to 236 of the second interface 23 are partially covered by the first interface 22, and thus only partial content of the selecting units 231 to 236 can be displayed. In detail, as shown in FIG. 2B, words showed on the selecting units 231 to 236 of the second interface 23 are not completely displayed at the touch display module 21, and at least a part of words on the selecting units 231 to 236 cannot be recognized by the user. The display ratio of each selecting units 231 to 236 is not limited, even whether the display ratio of each selecting units 231 to 236 are the same is also not limited herein and can be adjusted according to practical requirements. For example, in an embodiment, the selecting unit is displayed in large size which occupies half size of itself, and a smaller selecting unit is displayed in small size and may occupy a quarter in size of itself, both condition explains how a partial content been displayed.

FIG. 2C is a perspective schematic diagram showing that part of the display image in FIG. 2B. To make the embodiment clearly, the content of the first interface 22 in an area Z, such as texts and the selecting units 221, 222 in FIG. 2B, is not displayed. Comparing FIG. 2B and FIG. 2C, since the second interface 23 and the selecting units 231 to 236 thereon are covered or shielded by the first interface 22, it performs a visual effect that only a part of the selecting units 231 to 236 are displayed. The terms “covered” or “shielded” herein means the displaying result in visual. The corresponding technology to perform “covered” or “shielded” effect is well known by persons having ordinary skill in the art, which is omitted herein.

If the user wants to operate the second interface 23 and switches from the first interface 22 to the second interface 23, or wants to display the selecting units 231 to 236 of the second interface 23, he or she can perform a touch event on the touch display module 21.

In the embodiment, the touch event may be a single-touch or a multi-touch that performed on the touch display module 21. In detail, the single-touch includes clicking, touching, pressing or tapping the touch display module 21. After the single touch, a movement of moving for a distance in a straight line or a curve path may further be included. The movement includes single-touch or multi-touch in a predict direction path, a clockwise or a counterclockwise path, a moving outwards path, a moving inwards path or any other moving path performed by users on the touch display module 21, which is not limited herein.

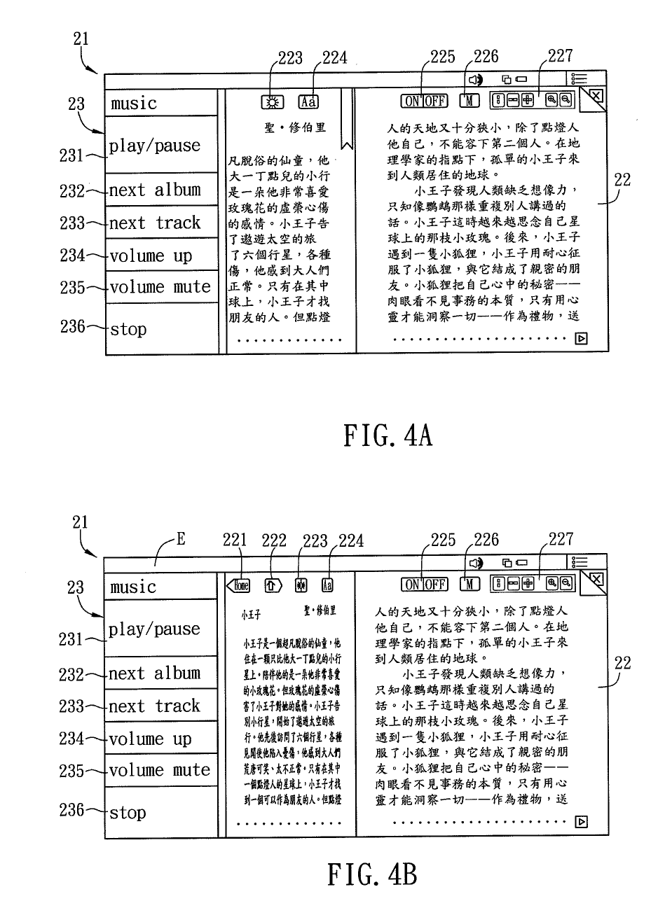

FIG. 3A and FIG. 3B are schematic diagrams showing that different actions are executed accordingly when the touch display module in the first embodiment receives different touch events. Touch events listed above are not limited to be performed on the area of the second interface 23 or the first interface 22 on the touch display module 21. More specifically, the touch event may be performed by directly touching part of the displayed content of the second interface 23 at the touch display module 21 (as shown in FIG. 3A), which is similar to the rules of selection. Or, the touch event may be performed by sliding on the second interface 23 or the first interface 22 on the touch display module 21, which is similar to the rules of moving the second interface 23 out (such as from the position “a” to the position “a′” as shown in FIG. 3B), or moving the first interface 22 away (such as from position “b” to position “b′” as shown in FIG. 3B) for partial display. In an embodiment, the selecting units 231 to 236 of the second interface 23 are displayed completely. In order to avoid content interference, a part of the first interface 22 is omitted in the figures.

The interface adjustment module 24 is coupled with the touch display module 21. After the touch display module 21 receives the touch event, the interface adjustment module 24 adjusts the first interface 22 to partially recognizably or completely display the selecting units 231 to 236 of the second interface 23 at the touch display module 21. In the embodiment, the interface adjustment module 24 may adjust the first interface 22 by zooming, moving, turning or rolling the first interface 22 to move away the part covering on or shielding the first interface 22 or the second interface 23 to recognizably or completely display the selecting units 231 to 236 of the second interface 23 for the user.

The term “recognizably display” herein means a displaying effect that comparing to a covered or shielded mode, the words, figures, traceries and modes on the object or area can be clearly distinguishable by users and the performance result can be more predictable.

The term “recognizably display” is not limited in displaying all information completely, but is determined by whether the displayed information can be distinguished from each other and provide the user prediction of operation result.

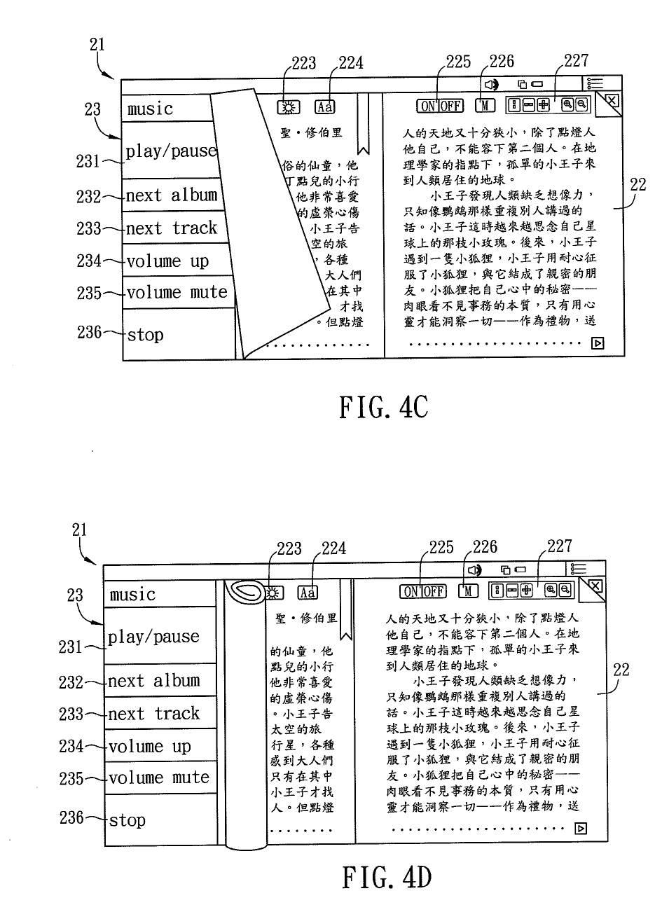

FIG. 4A to FIG. 4D are schematic diagrams showing images after a first interface is adjusted in different modes according to the first embodiment. The term “zooming” means to decrease the display content of the first interface 22 as shown in FIG. 4A or to reduce the display scale of the first interface 22 along a horizontal direction as shown in FIG. 4B. The meaning of terms “turning” and “rolling” is to show the images that simulating flexibilities of objects. FIG. 4C shows the effect of turning and FIG. 4D shows the effect of bending. Removing the cover or the shield from the second interface 23 may be in various methods. Persons having ordinary skill in the art know how to achieve it, which is omitted herein. All four modes described above can partially move to adjust the first interface 22. In addition, the first interface 22 also may be moved by completely translating the first interface 22 to one side, such as translating the first interface 22 to the right side in the embodiment.

After the interface adjustment module 24 adjusts the display content of the first interface 22, the touch display module 21 can partially display the selecting units 231 to 236 of the second interface 23 for the user to execute one operation in multitask operation. In FIG. 4A to FIG. 4D, the selecting units 231 to 236 of the second interface 23 can be displayed completely after the adjustment, the words can be completely displayed as so-called “recognizably displayed”. Taking the selecting units 232 and 233 of the second interface 23 as examples, before the adjustment, the selecting units 232 and 233 that showed in FIG. 2A are covered by the first interface 22 and only a part of the content can be displayed. Thus, the information cannot be read completely. After the adjustment, as shown in FIG. 4A, at least the words “next album” and “next track” at the selecting units 232 and 233 can be displayed, and the user can distinguish the words and predict the operation result. In other embodiments, the content of the selecting units is not limited. It may include figures, traceries, modes or combinations, which is not limited herein. If the display words “next album” and “next track” are the total content of the selecting units 232 and 233, the display words shown in FIG. 4A is the complete display of the selecting units 232 and 233.

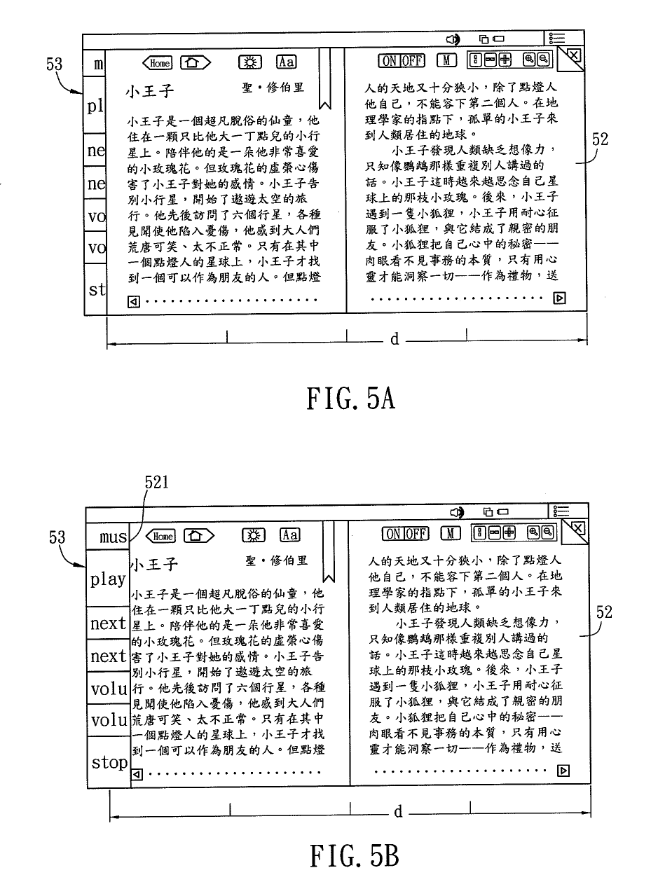

FIG. 5A, FIG. 5B and FIG. 5C are schematic diagrams showing the images of the first interface before adjustment or under the adjustment in a second embodiment. In the embodiment in FIG. 5A, the original length of the first interface 52 of the touch display module is “d”. In the adjustment, a complete touch event can be taken as a standard for determining whether the instruction is complete and thus switch to the second interface 53. For example, as shown in FIG. 5B, when the user slides along one side 521 of the first interface 52 to generate a touch event, if the sliding event only leads the length of the first interface 52 to be decreased less than one-quarter of the original length ‘d”, it is determined that the touch event is not an complete touch event to enable the adjustment, and the display content does not switch to the second interface 53. On the contrary, if the sliding event leads the length of the first interface 52 to a predetermined length, such as half to three-quarter of the original length, as shown in FIG. 5C. The touch event is determined to be a complete and appropriate touch event, and the interface adjustment module 24 would adjust and switch the display interface. In the embodiment, the touch event may trigger the interfaces switching if the length of the first interface 52 decreases to a predetermined length, and the touch event is performed along a horizontal direction. Furthermore, the display ratio of the first interface 52 and the second interface 53 is related to each other, therefore, although the first interface 52 is taken as an example in the embodiment, it also should be known that the second interface 53 can be switched when the length of the second interface 53 is increasing to achieve a threshold value.

According to the description above, it prevents a mis-touched error due to a switch threshold and thus to avoid an unexpected control and ensure usage smooth.

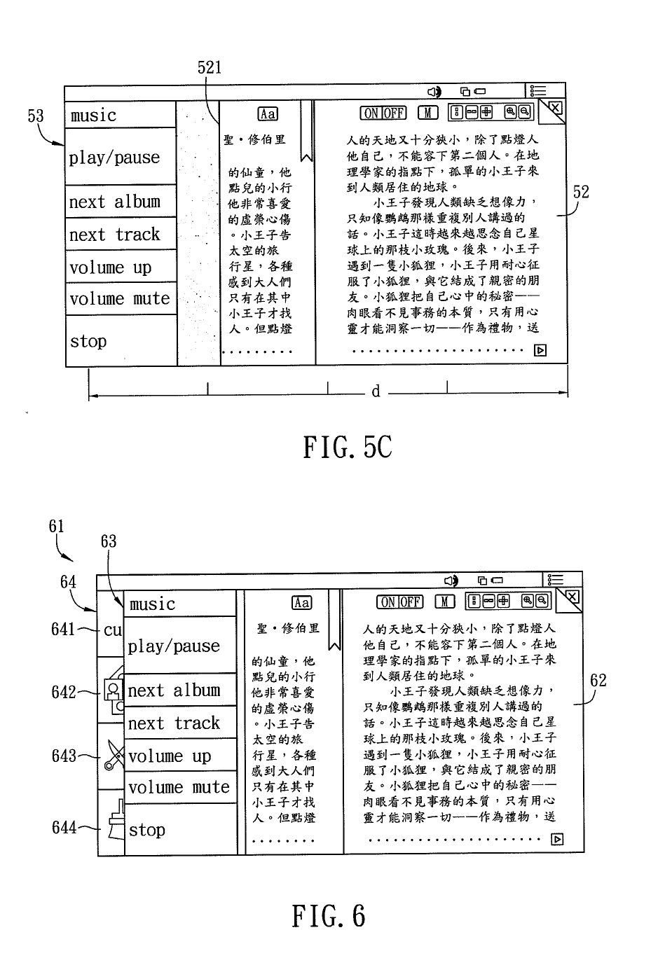

FIG. 6 is a schematic diagram showing display images of the touch display apparatus in a third embodiment. In the embodiment, the touch display module 61 of the touch display apparatus displays a first interface 62, a second interface 63 and a third interface 64. The third interface 64, the first interface 62 or the second interface 63 may display different interfaces when the same or different functions are executed. It also can be displayed by executing one or more different application programs or operation systems, which is not limited herein. A touch event that provided on the touch display module 61 to adjust the first interface 62 or the second interface 63, so as to partially, recognizably or completely display the selecting units 641 to 644 of the third interface 64 are similar to that described above. The display method is similar to that in the first embodiment, which is omitted herein for a concise purpose.

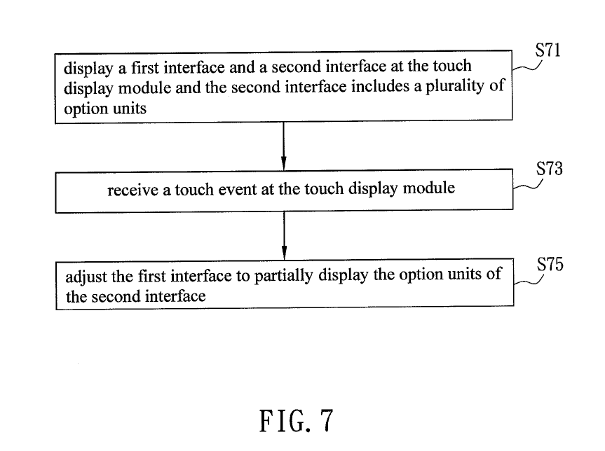

FIG. 7 is a flow chart showing an interface display adjustment method applied to a touch display module in an embodiment. The interface display adjustment method includes the following steps: displaying a first interface and a second interface on the touch display module, the second interface includes a plurality of selecting units (S71); receiving a touch event on the touch display module (S73); and adjusting the first interface to partially display the selecting units of the second interface (S75). However, the features and details of the interface display adjustment method are similar to that in the above embodiment, which is omitted herein.

In sum, according to the disclosure, the touch display module can display at least two interfaces under multitask processing, and since the selecting units of the second interface are covered or shielded by the first interface, the first interface in has a larger space to be displayed, which is more convenient for the user to operate and read. When the user wants to perform other operations, the selecting units of the second interface can be partially displayed by adjusting the first interface. After the touch events are performed, the interface display adjustment method in the embodiment can adjust the displayed first interface to display the selecting units of the second interface, partially or completely and recognizably. Since the second interface is not shown in a jumping or popping up mode, the user does not need to bring out previous memory to check the new frames or to look for the position of the selecting units again. The operation has no interruption, the man-machine coordination is closer, and the efficiency of simultaneous multitask and fluency of whole work are further increased.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An interface display adjustment method applied to a touch display module, comprising the following steps:
displaying a first interface and a second interface on the touch display module, wherein the second interface includes a plurality of selecting units, and part of the selecting units are covered by the first interface;
receiving a touch event at the touch display module; and
adjusting the first interface to partially display the selecting units that covered by the first interface.

2. The interface display adjustment method according to claim 1, wherein the first interface is adjusted by zooming, moving, turning or rolling.

3. The interface display adjustment method according to claim 1, wherein the step of adjusting the first interface includes displaying the selecting units completely.

4. The interface display adjustment method according to claim 1, wherein the first interface and the second interface are displayed by executing the same application program or different application programs.

5. The interface display adjustment method according to claim 1, wherein the touch event is a touch action at the first interface or at the second interface.

6. The interface display adjustment method according to claim 1, further including the following steps:
displaying a third interface including a plurality of the selecting units at the touch display module, and at least part of the plurality of selecting units of the third interface are covered by the first interface or the second interface;
receiving another touch event via the touch display module; and
adjusting the first interface or the second interface to partially display the selecting units that covered by the first interface or the second interface.

7. A touch display apparatus comprising:
a touch display module displaying a first interface and a second interface, and at least part of the plurality of selecting units of the second interface are covered by the first interface; and
an interface adjustment module coupled with the touch display module,
wherein when the touch display module receives a touch event, the first interface is adjusted to partially display the part of the plurality of selecting units of the second interface covered by the first interface.

8. The touch display apparatus according to claim 7, wherein the interface adjustment module adjust the first interface by zooming, moving, turning or rolling the first interface.

9. The touch display apparatus according to claim 7, wherein the interface adjustment module adjusts the first interface to display the selecting units completely.

10. The touch display apparatus according to claim 7, wherein the interface adjustment module executes the same application program or different application programs to display the first interface and the second interface.

11. The touch display apparatus according to claim 7, wherein the touch event is a touch at the first interface or a touch at the second interface.

12. The touch display apparatus according to claim 7, wherein the interface adjustment module displays a third interface including a plurality of the selecting units, and at least part of the plurality of selecting units of the third interface are covered by the first interface or the second interface selecting units, and when the touch display module receives another touch event, the first interface or the second interface is adjusted to partially display the part of the plurality of selecting units of the third interface covered by the first interface or the second interface selecting units.
